(19) United States
(12) Patent Application Publication
(10) Pub. No.: US 2003/0156153 A1
(43) Pub. Date: Aug. 21, 2003

(54) Ink jet recording apparatus

(75) Inventor: Tetsuya Ishikawa, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/354,005

(22) Filed: Jan. 30, 2003

(30) Foreign Application Priority Data
Feb. 15, 2002 (JP) 038905/2002

(51) Int. Cl. B41J 2/165

(52) U.S. Cl. 347/29

(57) ABSTRACT

An ink jet recording apparatus for recording by discharging ink from recording means comprises: a cap for covering a discharge port surface of the recording means; suction means for sucking ink from the discharge ports; and ink flow paths connecting the suction port arranged for the cap to the suction means, in which after sucking ink from the discharge ports by the suction means, there is made apart the opposite side of the cap to the side where the suction port is arranged, and when the cap and the recording means are set apart, the cap is horizontally postured or in a posture having the side of the suction port arranged therefor made lower than horizontal. With the structure thus arranged, it becomes possible to suck and remove ink remaining in the cap and others efficiently when the cap is made apart and the idle suction is performed inside the cap after the suction recovery process or the like for the maintenance of stable ink discharge performance at all the time.

### BACKGROUND OF THE INVENTION

1. Field of the Invention

The present invention relates to an ink jet recording apparatus that records by discharging ink from recording means to a recording material.

2. Related Background Art

A recording apparatus, which is provided with the function of a printer, a copying machine, a facsimile equipment, or the like, or a recording apparatus, which is used as an output equipment for a complex electronic equipment, a work station, or the like, that includes a computer or a word processor, among some others, is structured to record images (including characters, symbols, or the like) on a recording material (recording medium) such as paper, cloth, plastic sheet, OHP sheet in accordance with image information (recording information). The recording apparatuses are classified into ink jet type, wire-dot type, thermal type, and laser beam type, among some others, depending on the recording method that each of them adopts.

In the serial type recording apparatus, which records, while performing the main scans in the direction intersecting with the conveying direction of a recording material, forms images by discharging ink from a recording head serving as recording means, while it moves (performs main scans) along the recording material, and a sheet feeding of a predetermined amount (pitch conveyance serving as a sub-scanning) is effectuated subsequent to the completion of image formation of one line portion. Then, after that, the recording (main scanning) of the images of the next portion is performed on the recording material, which is made stationary again. Such operation is repeated to complete the entire recording on the recording material. On the other hand, in the line type recording apparatus, which records only by sub-scanning in the conveying direction of a recording material, the recording material is set at a predetermined recording position, and then, after the recording of one line portion is executed altogether, the sheet feeding of a predetermined amount is effectuated, and the recording of the next line is performed altogether, and by repeating such operation, the recording is made on the recording material entirely.

Among these types of recording apparatuses, the ink jet type recording apparatus (ink jet recording apparatus) performs the recording by discharging ink from an ink discharge portion thereof to a recording material, which makes it easier to arrange the recording head compactly for the recording of highly precise images at high speed. Also, there are advantages, among many others, that the recording can be done on a plain paper without special treatment and thus the running cost of the apparatus is made lower, and that, being non-impact type, the apparatus makes lesser amount of noises, and, further, color images can be formed with ease by use of many kinds of ink (various colors of ink, for example).

For the ink jet recording apparatus that records by discharging ink from the discharge ports formed in recording means to a recording material, there is provided discharge port protection means or discharge recovery process means in order to eliminate clogging of the discharge ports due to dried ink or ink discharge defects due to dust particles, bubbles, or the like in the discharge ports.

The main structure of the discharge port protection means is capping means, which covers a discharge port surface of the recording head serving as recording means by use of a cap formed by elastic material, such as rubber. Also, the main structure of the discharge recovery process means is suction recovery means for removing what causes ink discharge defects, together with ink from the inside of the cap by means of the suction or pressure reduction by negative pressure generating means, such as pump, to forcibly discharge ink from the discharge ports; pre-discharge means that discharges ink from the discharge ports for the purpose other than recording; and wiping means that removes ink and other adhesion to the discharge port surface, among some others.

Also, for the negative pressure generating means (suction means) that reduces the inner pressure of the cap, a piston pump, a tube pump, or the like is used. Also, as suction means for removing ink residing in the cap or in the ink flow path formed by tube or the like after suction, there are mainly two means. A first means is the “cap-open idle suction”, which performs suction while keeping the cap apart from the recording head. For example, cap-open suction means has been proposed in Japanese Patent Application Laid-Open No. 03-093548, in which a cap is released, while being inclined, without any provision of valve mechanism for atmospheric communication. A second means is the “cap closed idle suction”, which performs suction after the inside of the cap is made to be communicative with the atmosphere by use of the atmosphere communication mechanism provided with a valve capable of keeping the inside of the cap communicative with the atmosphere in a state of being capped. The atmosphere communication mechanism in this case is, in general, structured by a tube communicated with the inside of the cap, and the atmosphere communication valve arranged at the leading end of the tube, which is made freely open or closed. The cap closed idle suction is disclosed in the specifications of U.S. Pat. No. 5,153,613 and others, for example. The suction of the kind is characterized in being capable of effectuating more reduction of ink remainders than the cap-open idle suction.

The cap-open idle suction makes it easier to provide the suction mechanism smaller at lower costs, but such drawback that ink in the cap drops off into the recording apparatus may be encountered, because the cap is almost in the horizontal posture when it is open to discharge ink substantially in the horizontal direction, for example.

Moreover, along with the enhancement of image quality that has been increasing in demand, the precision of ink discharge position becomes more important in recent years, and thus, in terms of the discharge stabilization, the discharge ports of a recording head tends to be installed almost horizontally to enable ink to be discharged downward vertically. A mechanism of the kind is now considered as a main current. In such a mechanism, if a cap is released diagonally from the opposite side of the suction port provided thereon in order to induce the air into the cap, the suction port of the cap is positioned on the upper side of the cap thus inclined (on the side higher in the vertical direction). As a result, drawback is encountered such as to make it difficult to suck ink from the inside of the cap by a pump for the sufficient removal of ink.

Particularly, in a case of pigment ink, if the cap absorbent formed by the material having large pore diameter is used for the prevention of clogging, the propagating speed of pigment ink in the ink absorbent is made slower (the ink propagation becomes difficult). As a result, if the posture of the cap is arranged so as to position the suction port to be on the lower side of the inclination as described earlier, there encountered a drawback that the capability of ink collection is made extremely low.

Then, if ink is not removed from inside the cap sufficiently, ink is caused to adhere to the discharge port surface in the succeeding operations, such as the next opening or closing of the cap. Consequently, the ink that has adhered is transferred to the carrier systems or ink spreads greatly when being wiped. Further, ink adheres to the blade, which is accumulated thereon in a short period of time, and brings about a drawback that the wiping performance is made lower, among some others.

On the other hand, when using such an atmosphere communication mechanism as the cap closed idle suction, the performance of ink removal capability is high. But, it is unavoidable that not only the cost of suction means is higher, but also, the size thereof becomes greater. Moreover, when the atmosphere communication mechanism is used, the inside of the atmosphere communication tube is made a negatively pressurized chamber if the suction operation is performed in a state where the atmosphere communication valve is closed. As a result, ink forcibly discharged from the recording head enters the interior of the atmosphere communication mechanism, and the ink thus entered is dried unless the entered ink in the atmosphere communication mechanism is discharged exactly by the idle suction that follows immediately thereafter. Thus, a drawback is encountered such as to clog the atmosphere communication port eventually in some cases.

### SUMMARY OF THE INVENTION

It is an object of the present invention to provide an ink jet recording apparatus capable of minimizing the amount of ink remaining in the cap, on the discharge port surface of recording means and the like, and maintaining stable ink discharge performance at all the time, by efficiently sucking and removing ink remaining in the cap and others when the cap is made apart and the idle suction is performed inside the cap immediately after the suction recovery process or the like.

It is another object of the invention to provide an ink jet recording apparatus for recording by discharging ink from recording means, which comprises: a cap for covering a discharge port surface of the recording means; suction means for sucking ink from discharge ports; and ink flow paths connecting a suction port arranged for the cap to the suction means, wherein after sucking ink from the discharge ports by the suction means, there is made apart the opposite side of the cap to the side where the suction port is arranged, and when the cap and the recording means are set apart, the cap is horizontally postured or in a posture having the side of the suction port arranged therefor made lower than horizontal.

### BRIEF DESCRIPTION OF THE DRAWINGS

FIG. 1 is a perspective view that shows the external appearance of an engine unit (a portion that performs recording operation) of an ink jet recording apparatus to which the present invention is applicable.

FIG. 2 is a perspective view that shows the structure of a recovery unit of the ink jet recording apparatus to which the present invention is applicable.

FIG. 3 is a side view that schematically shows a driving mechanism of the recovery unit represented in FIG. 2.

FIGS. 4A, 4B, and 4C are cross-sectional views that schematically illustrate the positional posture of a cap of a discharge recovery device with respect to recording means for the ink jet recording apparatus to which the present invention is applicable; FIG. 4A shows the condition under which the cap is open during the recording operation or the like; FIG. 4B shows the capping condition at the time of executing a suction recovery process or the like; and FIG. 4C shows the condition under which the side opposite to a suction port of the cap is made apart from a discharge port surface, while enabling the cap to be inclined when the idle suction or the like is executed.

FIG. 5 is vertically sectional view that shows the state of generating negative pressure by a tube pump serving as negative pressure generating means for the recovery unit of the ink jet recording apparatus to which the present invention is applicable.

FIG. 6 is vertically sectional view that shows the state of releasing the compression squeeze of the pump tube by rotating the tube pump represented in FIG. 5 in the opposite direction.

FIG. 7 is a flowchart that shows a series of recording operation and recovery process in the ink jet recording apparatus to which the present invention is applicable.

FIG. 8 is a flowchart that shows an operation of a pre-discharge process described in FIG. 7.

FIG. 9 is a flowchart that shows an operation of a wiping process described in FIG. 7.

FIG. 10 is a flowchart that shows the operation of the suction recovery process described in FIG. 7.

FIG. 11 is a perspective view that schematically shows a second embodiment of the ink jet recording apparatus to which the present invention is applicable.

FIG. 12 is a side view that schematically shows the posture of recording means and the cap when the idle suction is performed for the ink jet apparatus represented in FIG. 11.

FIG. 13 is a partial perspective view that schematically shows the structure of the ink discharge portion of recording means of the ink jet recording apparatus represented in FIG. 1.

### DETAILED DESCRIPTION OF THE PREFERRED EMBODIMENTS

Hereinafter, with reference of the accompanying drawings, the description will be made of the embodiments specifically in accordance with the present invention. In this respect, the same reference marks designate the same or corresponding parts throughout in each of the accompanying drawings.

(First Embodiment)

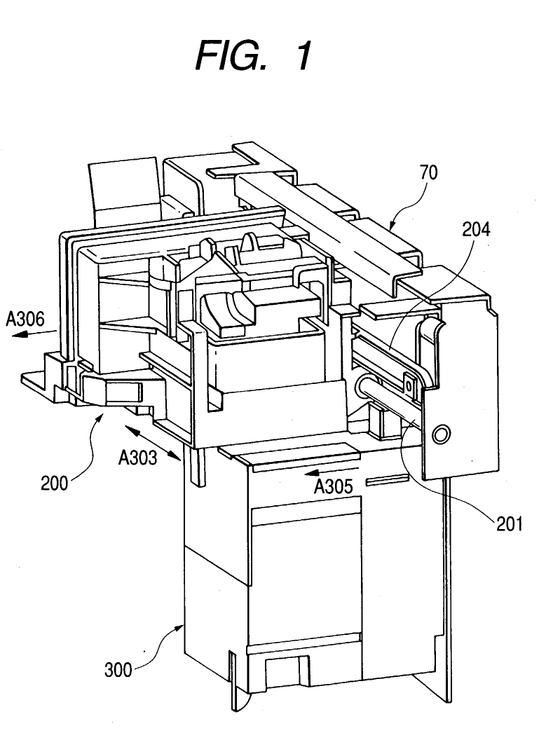

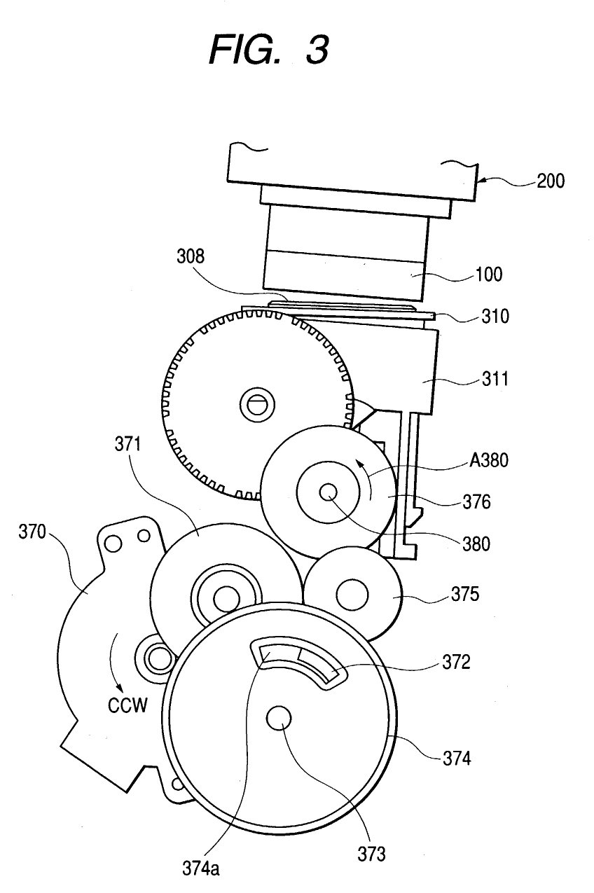

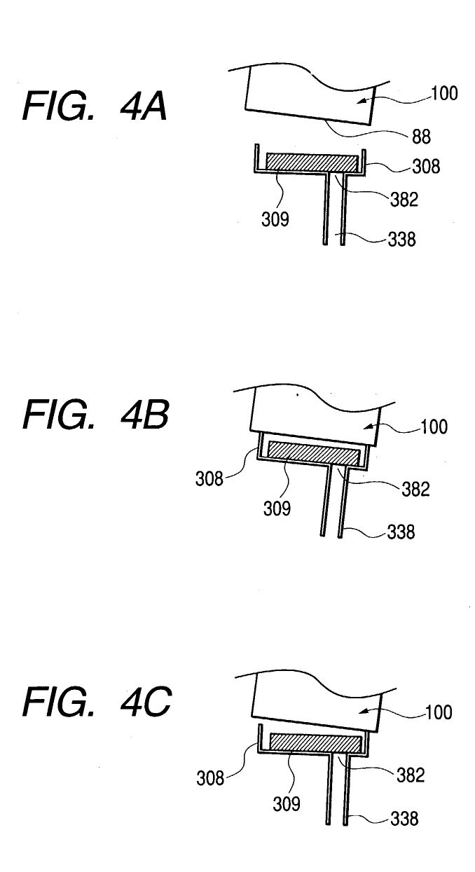

FIG. 1 is a perspective view that shows the external appearance of an engine unit (the portion that performs recording operation) of an ink jet recording apparatus to which the present invention is applicable. In FIG. 1, the ink jet recording apparatus is provided with a recording head 100 (see FIG. 3 and FIGS. 4A to 4C) that serves as recording means for recording by discharging ink, and a carriage unit 200 having the recording head 100 mounted thereon, which is movable in the direction indicated by a double head arrow A303, and guided and supported by a guide shaft 201 through a timing belt 204 driven by a carriage motor (not shown).

In other words, the carriage unit 200 that mounts the recording head 100 is structured to be movable along the guide shaft 201 in the directions indicated by the arrow A303 across the left and right sides (the depth side and the front side in FIG. 1) of the recording position and the stand-by position on the central portion. In this respect, an arrow A305 indicates the conveying direction of a recording sheet on one side, and an arrow A306 indicates the conveying direction of the recording sheet on the opposite side (the other side).

The ink jet recording apparatus is further provided with an ink supply unit (not shown) for supplying ink to the recording head 100; a recovery unit 300 for maintaining and recovering the ink discharge characteristics of the recording head 100; and a frame unit 70 for fixing the guide shaft 201, and also, for housing and fixing the recovery unit 300.

Here, the lower side face (downward surface) of the recording head 100 (see FIG. 3 and FIGS. 4A to 4C) is made to be a discharge port surface formed with plural discharge ports in a predetermined arrangement. The discharge port surface is inclined at an angle of approximately 5 degrees to the horizontal plane.

The recording head 100 utilizes thermal energy for discharging ink, which is provided with electrothermal converting element that generates thermal energy. Also, the recording head 100 discharge ink from the discharge ports for the formation of images by the utilization of pressure changes generated by the growth and shrinkage of bubbles by means of film boiling generated by the thermal energy applied by the electrothermal converting element.

FIG. 13 is a partial perspective view that schematically shows the structure of the ink discharge portion of recording means of the ink jet recording apparatus 100. In FIG. 13, there are formed on a base plate 81 of the recording head 100, plural electrothermal converting elements 82 and corresponding wires thereto by the same manufacturing processes as those used for semiconductor (such as a method for forming thin film) through a thin film layer 83. Each of the electro-thermal converting elements 82 is arranged on the position corresponding to each discharge port 89 and liquid flow path 86 as shown in FIG. 13. Then, a flow path formation member 84, which is provided with plural flow path walls 84A formed in parallel on the lower face thereof at predetermined intervals, is bonded to the base plate 81 (to the think film 83 on the base plate 81), and further, a ceiling plate 85 is bonded to the upper face of the flow path formation member 84. Here, on the base plate 81, the electric wiring, which contains the electrothermal converting element 82, the flow path formation member 84, and others are bonded. Thus, a discharge element base plate is structured.

The flow path 86 is formed between each of flow path walls 84A. Here, the flow path formation member 84 is positioned and bonded to the base plate 81 (to the think film 83 on the base plate 81) in such a positional relation that each of aforesaid electrothermal converting elements 82 is arranged on the designated inner position of each of the flow paths 86. Each flow path wall 84A has a predetermined length, and the rear end of each flow path 86 is communicated with a common liquid chamber 87, which is formed between the flow path formation member 84 and the base plate 81 (or the thin film 83). On the other hand, the other end (the front end) of each low path 86 is open to a discharge port surface (the surface having the specifically arranged discharge ports 89 formed thereon) 88 of the recording head 100, thus forming the discharge port 89 with each of such opening portions.

In this manner, the electrothermal converting element 82, such as heat generating resistive member, is energized (with the application of pulse voltage) to enable it to generate heat. The recording head 100 of ink jet type is thus structured to generate film boiling in ink in the flow path 86, and discharge ink droplets from the discharge port 89 with the pressure changes exerted at that time. The recording head 100 is installed in such a posture that the arrangement direction of the plural discharge ports 89 intersect with (substantially orthogonal to) the conveying directions A305 and A306 of a recording material, and then, the distance between the discharge port surface 88 and the recording material (that is, a clearance to a paper sheet) is selected to be approximately 0.3 mm to 2.0 mm.

If dust particles should adhere to the discharge port surface of the recording head 100 or to the vicinity thereof or if the ink, which adheres to the inner part of the discharge port or to the discharge port surface, is dried or becomes overly viscous, the ink discharge performance of the recording head 100 is made inferior eventually, resulting in disabled discharges or twisted discharges (that cause displacement of impact positions of ink droplets which have been discharged in the irregular directions). Now, therefore, the description will be made, at first, of the recovery unit 300, which is used for the recovery and maintenance of the discharge performance by eliminating defective ink discharges such as disabled discharges, twisted discharges, among some others.

The recovery unit 300 embodying the present invention is provided with pre-discharge process means; wiping process means; and suction recovery process means as the main discharge recovery process means given below.

At first, the pre-discharge process means performs ink discharge from all the discharge ports 89 at predetermined timing in an area other than a recording sheet, that is, a designated area provided for the recovery unit 300 in accordance with the present embodiment. In this way, overly viscous ink in the discharge port or the vicinity of the discharge port is discharged or the ink of other kinds, which enter the discharge port when plural kinds of ink are made dischargeable in the same recording apparatus, is discharged. The ink that has been discharged by the pre-discharge process is carried to a waste ink tank.

Also, the wiping process means is provided for wiping and removing the ink that adheres to the discharge port surface due to the mist that should be generated simultaneously with the main ink droplets discharged for recording; or due to the splashed mist that should be generated when the main ink droplets are impacted on a recording sheet; or by the suction recovery process, as described later, which is performed by sucking ink from the discharge port. Here, the wiping process means comprises the blade (wiper), which is formed by elastic member such as rubber for wiping to clean (cleaning) the discharge port surface, and some others.

Also, the suction recovery process means is arranged to push the cap, which is formed by rubber or some other elastic material, to the discharge port surface 88 of the recording head 100 to have it be closely in contact therewith, and by use of pumping means, the inner pressure of the cap is reduced to less than the atmospheric pressure, thus forcibly discharging ink from the discharge port. Then, together with the flow of ink, dust particles, dried ink, or all the elements that cause the discharge impedance, such as bubbles, in the discharge port are eliminated. The ink that has been sucked by the suction recovery process means is carried to the waste ink tank by an idle suction process, which will be detailed later.

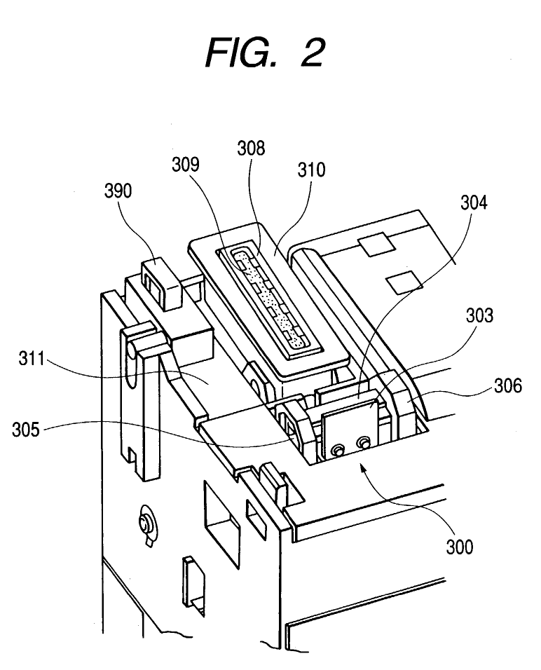

FIG. 2 is a perspective view that shows the structure of the recovery unit 300 of the ink jet recording apparatus to which the present invention is applicable. In FIG. 2, the recovery unit 300 is fixed to the frame unit 70, to which the guide shaft 201 and other carriage traveling guide members are fixed, hence securing the relative positions between the recovery unit 300 and the carriage unit 200 (the carriage and the recording head) in good precision.

In FIG. 2, a reference numeral 303 designates the blade formed by a flat plate of elastic material, such as rubber. Each blade 303 is fixed to a blade holder 304. The blade holder 304 is elastically biased to engage with a blade shaft 305 by a blade spring (not shown) so that each blade 303 is in a rotative position in which the blade faces the recording head 100, that is, it is set in the upward direction. The blade shaft 305 is integrally formed with a blade gear 305a.

Also, the blade shaft 305 is formed to be rotative by blade driving means (not shown), and the blade holder 304 engaged with the blade shaft 305 and each blade 303 are also arranged to be rotative in the same manner together with the blade shaft 305. Further, for the blade holder 304, a blade cam 306 is integrally formed. Then, when the carriage unit 200 moves on wiping means in the direction indicated by an arrow A303, the blade cam 306 is pressed down elastically by the blade rib (not shown), which is arrange for the carriage. In this way, irrespective of the positional tolerance of installation between the recording head 100 and the recovery unit 300 in the height direction, the amount of intrusion is made always stable so as to make the wiping process executable in good condition at all times.

In FIG. 2, a reference numeral 308 designates the cap, which is formed by an elastic material, such as rubber; 309, a cap absorbent formed by a porous material made by polyethylene or the like, which is provided for the inside of the cap 308. The cap absorbent is the porous material, which is formed by sintering powdered polyethylene having a diameter of approximately 0.3 mm. The pore ratio is approximately 40%, for example.

A reference numeral 310 designates the cap holder that holds the cap 308, and 311, a cap lever. The cap holder 310 is fixed to the cap lever 311 in such a manner that it is biased in the direction toward the recording head 100 through a cap spring (not shown). Also, the cap lever 311 is structured to be movable up and down for opening or closing the cap 308 by use of a cap lever cam (not shown) fixed to the camshaft of the recovery unit 300.

In other words, in FIG. 1 and FIG. 2, the carriage unit 200 is at the home position when it lies immediately above the recovery unit 300, and it is made movable in the direction indicated by the arrow A303 intersecting with (usually, orthogonal to) the conveying directions of a recording sheet indicated by arrows A305 and A306. When the carriage unit 200 is positioned above the conveying pass of the recording sheet by moving it to one side of the recovery unit 300, recording is made possible on the recording sheet, which is conveyed in the direction indicated by the arrow A305. Also, when the carriage unit 200 moves to the other side (opposite side) of the recovery unit 300 so as to be position on the conveying path of the recording sheet, recording is made possible on the recording sheet conveyed in the direction indicated by the arrow A306.

In FIG. 2, a reference numeral 390 designates a carriage lock arm, which engages with a hole provided for the carriage when capping the recording head 100 on the carriage 200 positioned immediately above the recovery unit 300, that is, when the cap lever 311 rises. By the function of the carriage lock arm 390, the carriage is fixed to the regular position so that any positional deviation should not occur between the recording head 100 and the cap 308 due to shocks or the like.

Also, a lock spring (not shown) is arranged between the carriage lock arm 390 and the cap lever 311, and the structure is arranged so as to enable the carriage lock arm 390 to be elastically lowered with respect to the carriage lever 311. In this manner, even if the carriage lock arm 390 abuts against a portion other than the hole that faces the carriage, there is no damage that may be given to the recovery unit 300 or the carriage unit 200.

FIG. 3 is a side view that shows the structure of the driving systems of the recovery unit 300 represented in FIG. 2, and also, the relations between the cap and the recording head. In FIG. 3, a reference numeral 370 designates a motor dedicated for use of the recovery systems, which is provided with a gear fixed to the rotational shaft thereof; 371, a first double gear for speed reduction use, which is an intermediate gear of the motor; and 372, the idler gear, which is formed to engage with the first double gear 371, while rotating around the pump shaft 373 to which is fixed a roller guide of a tube pump 324 to be described later.

In FIG. 3, a reference numeral 374 designates a pump cam, which is fixed to the pump shaft 373, and provided with a cut-off portion 374a that engages with a rib provided for the idler gear 372. Between the rib and the cut-off portion 374a, a play having a predetermined angle (rotational angle of 55 degree-portion, for example) is arranged; 375, a second double gear that engages with the idler gear 373; and 376, a one-way clutch formed integrally with the gear that generates tightening torque only when it rotates in the predetermined direction.

The one-way clutch 376 enables a camshaft 380 to rotate for driving by generating the tightening torque to the camshaft 380, which is the rotational center thereof, only when it rotates in the direction indicated by an arrow A380 in FIG. 3 (that is, in the CCW direction). In other words, only when the motor 370 dedicated for use of the recovery systems driving rotates in the CCW (counterclockwise direction) indicated by the arrow in FIG. 3, the camshaft 380 of the recovery unit 300 is enabled to rotate for driving by the rotation of the one-way clutch 376 in the direction indicated by the arrow A380 (CCW direction). On the other hand, when the motor 370 dedicated for use of the recovery systems driving rotates in the CW (clockwise) direction, which is opposite to the direction indicated in FIG. 3, the one-way clutch 376 is made free, and the camshaft 380 of the recovery unit 300 does not rotate. Then, the pump shaft 373 begins to rotate with a predetermined play.

With the structure thus arranged, when rotating the pump regularly to generate suction pressure, no driving power is transmitted to the cap and the valve mechanism. Here, on the contrary, the pump rotates reversely in driving the cap to enable the roller to retract.

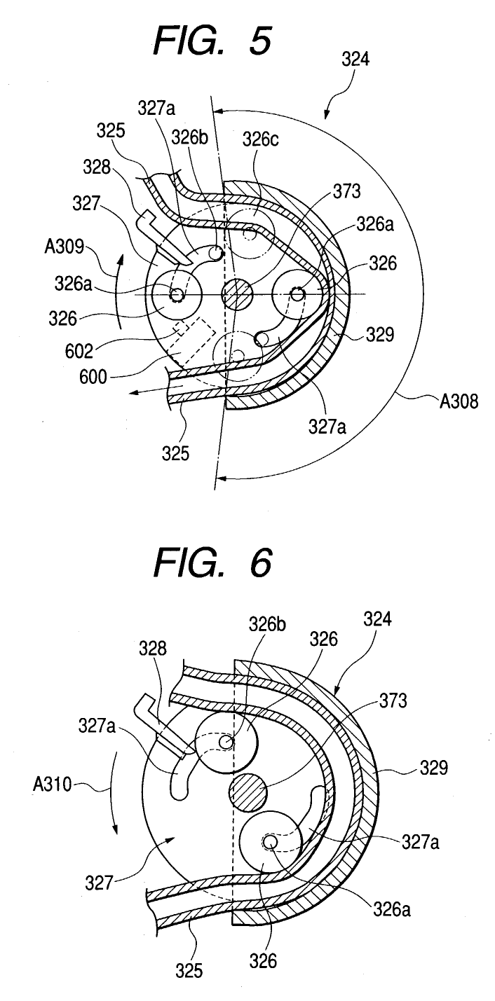

Also, the downward discharge port surface 88 of the recording head 100 is inclined at an angle of approximately 5 degrees to the horizontal plane. On the other hand, the cap 308, which is in the opening state, is inclined at an angle of approximately 3 degrees to the discharge port surface 88. Therefore, the abutting surface of the cap 308 against the discharge port surface 88 is inclined at an angle of approximately 2 degrees to the horizontal plane. Here, the position of a suction port 382 provided for the cap 308 (see FIGS. 4A to 4C) is at the right end of the cap 308 in FIG. 3 and FIGS. 4A to 4C, that is, on the lower part of the inclined cap 308 (having an inclination with the lower right at an angle of approximately 2 degrees to the horizontal plane). In this respect, the suction port 382 is connected with the tube pump 324 (see FIG. 5 and FIG. 6) serving as the supply source of negative pressure through the cap tube 338.

FIGS. 4A, 4B, and 4C are cross-sectional views that schematically illustrate the positional posture of the cap 308 with respect to the recording head 100; FIG. 4A shows the condition under which the cap is open during the recording operation or the like; FIG. 4B shows the capping condition at the time of executing the suction recovery process or the like; and FIG. 4C shows the condition under which the side opposite to the suction port 382 of the cap 308 is made apart from the discharge port surface 88, while enabling the cap to be inclined at the time of the idle suction or the like.

During the recording operation or the like, the cap 308 is kept away from the discharge port surface 88 of the recording head 100 as shown in FIG. 4A.

When the suction recovery process is performed, the cap-lever cam (not shown), which is fixed to the camshaft 380, is driven to rotate to raise the cap lever 311 as shown in FIG. 4B. In this manner, the cap 308 is biased elastically to be closely in contact with the discharge port surface 88 of the recording head 100. In the capping condition where the discharge port 89 is airtightly closed with the close contact of the cap 308, the suction pump (tube pump) 324 is driven to make the interior of the cap 308 negatively pressurized, thus sucking ink from the discharge port 89 for the execution of the suction recovery.

After the execution of the suction recovery process, the idle suction is given in order to discharge remaining ink in the cap 308, a cap tube 338, and others for the removal thereof. The idle suction is performed in such a manner that while the cap 308 is inclined as shown in FIG. 4C, a part of the cap rib (air tightening rib) positioned on the opposite side of (the side opposite to) the suction port 382 of the cap is allowed to part from the discharge port surface 88, and then, the suction pump 324 is driven to enable the air to flow into the inside of the cap 308 forcibly and continuously, thus discharging the ink that has adhered to the inside of the cap 308 and the discharge port surface 88 for removal by sucking such ink together with the air. At this juncture, the portion where the suction port 382 is arranged for the cap 308 is slightly lower than the horizontal plane. As a result, there is no fear that ink inside the cap 308 runs over or drops off. Also, the discharge port surface of the recording head 100 is lowered (inclined) toward the suction port 382. Therefore, the ink that has adhered to the discharge port surface 88 flows to the suction port 382 side, and gets together in the vicinity of the suction port 382.

In this respect, the forcible and continuous flow-in of the air into the cap 308 means that the air flows instantaneously when the cap 308 is released aslant, and also does that the air is continuously taken into the cap 308 by driving the suction pump 324 under the condition described above. In addition to the idle suction of the kind, the suction pump may be driven intermittently for the purpose, for example, which is also within the range of the present invention. The intermittent suction makes it possible to enhance the ink collection ratio more than the continuous idle suction, because with such kind of suction a time is provided for ink to be condensed by the surface tension of ink itself.

Also, in the case of the pigment ink that makes clogging easier, there is a need for the provision of large pores for the cap absorbent 309 so as to make the occurrence of clogging difficult. With the pores being made larger, the holding power of the cap absorbent becomes weaker against the ink that has been absorbed in the cap absorbent. Then, ink tends to flow more easily in the vertical direction and drop off. In this case, therefore, the suction port 382 is arranged at the lower end portion of the inclination of the cap 308, thus making it more effective to collect ink. After the idle suction sufficiently, the cap 308 is again kept in the cap open condition as shown in FIG. 4A where it parts from the discharge surface 88 of the recording head 100 completely. In this cap open condition, the wiping process for the discharge port surface 88, the pre-discharge process for the discharge ports 89, and some others are executed, and lastly, the idle suction for the cap 308 is executed. Then, the cap 308 is pressed to be in contact with the discharge port surface 88, thus keeping it in the capping condition as shown in FIG. 4B.

In this respect, when the cap is in the cap open condition, ink in the cap is removed sufficiently. Therefore, there is no possibility of such drawback as running out of ink in the cap. Thus, there is no problem even if the cap 308 is in parallel to the discharge port surface 88 substantially in the horizontal direction. Here, if the cap is conditioned to be in parallel therewith, a projection area on the inner side of a cap rib (circumferential airtight portion) becomes the largest against the discharge port surface of the recording head 100. As a result, it becomes possible to provide the maximum displacement margin when the pre-discharges are effectuated in the cap. In addition, it is made possible to expand the clearance between the discharge port surface and the cap.

Also, in accordance with the present embodiment, the suction pump begins to be driven after the cap 308 is inclined to release only the one side portion thereof, but it may be possible to arrange the structure so that the releasing operation of the cap 308 and the driving of the suction pump can be performed at the same time in the transition process from the airtight condition (capping condition) as shown in FIG. 4B to the releasing of one side portion as shown in FIG. 4C. With the structure thus arranged to make the simultaneous drive (simultaneous operation) possible, the enhancement of the throughput of the recording operation and recovery process operation is made attainable, while achieving further reduction of ink remainders in the cap 308.

In this respect, the movement of the cap 308 is not necessarily limited to that described in the present embodiment. For example, the cap may be released by reversing the inclination as if it were swung. More specifically, the structure may be arranged so that the cap 308 is inclined to the recording head 100 so as to enable the opposite side of (the side opposite to) the suction port 382 to be apart, and after that, the portion on the opposite side of the suction port 382 is lowered. With the structure thus arranged, it is not always nessessary to incline the recording head 100 to the horizontal plane. The same functional effect is attainable even if the cap is kept horizontal.

Next, in conjunction with FIG. 5 and FIG. 6, the description will be made of the structure of the tube pump 324. FIG. 5 is a vertically sectional view that shows the state of the tube pump 324 as negative pressure generating means, in which negative pressure is exerted. FIG. 6 is a vertically sectional view that shows the state in which the tube pump 324 represented in FIG. 5 rotates in the opposite direction (the direction indicated by an arrow A310).

In FIG. 5 and FIG. 6, a reference numeral 325 designates the pump tube formed by silicone rubber; 326, a roller that squeezes the pump tube 325 to generate negative pressure inside the pump tube; 326a, shaft portions arranged on both sides of the roller 326. The roller 326 is capable of pressing and squeezing the pump tube 325 while rotating (revolving) along the rotational movement (revolution) of a roller guide 327, and arranged to in two locations with 180-degree phase deviation.

A reference numeral 327 designates the roller guide that supports each roller 326 to be rotative (freely rotational); 327a, grooves provided for the roller guide 327 corresponding to each roller 326. Into each of the grooves 327a, the shaft portions 326a arranged on both sides of the corresponding roller 326 is inserted. Each roller 326 is structured to be movable along each groove 327a. A reference numeral 328 designates a roller dumper, which is formed by elastic material, such as rubber to reduce noises generated along the movement of the roller 326.

In FIG. 5, which shows the state where negative pressure is generated by the operation of the tube pump 324, the roller 326 moves to the end portion on the outermost circumference of the groove 327a of the roller guide 327. In this state, when the roller guide 327 rotationally moves (revolves) in the direction indicated by an arrow A309 (regular direction), the roller 326 rotates (revolves), while rotationally moving to press and smash the pump tube 325, thus squeezing the pump tube 325. In the area outside the area A308 where pump tube is squeezed, the roller dumper 328 keeps the roller 326, which is freely movable in the groove 327a, in a condition under which the roller is brought exactly to one end portion of the groove 327a (the end portion on the outermost circumference of the roller guide 327). Also, the two rollers 326 are given 180-degree phase deviation. Here, however, since a tube guide 329, which guides and holds the pump tube 325 in the form of arc, is arranged for an area having more than 180 degrees as indicated at A308, it is made possible to generate negative pressure continuously by squeezing the pump tube 326 continuously and endlessly during the rotational movement of the roller guide 327 in the direction indicated by the arrow A309 (regular direction).

FIG. 6 shows the condition in which the roller guide 327 rotates in the direction (indicated by an arrow A310), which is opposite to the one represented in FIG. 5. In the condition shown in FIG. 6, the roller 326 is pushed in the groove 327a in the direction opposite to the one shown in FIG. 5 due to a load exerted by interference with the pump tube 325, and then, roller 326 in the condition (retracted condition) where it escapes toward the rotational center of the roller guide 327 (in the direction of the pump shaft 373). Therefore, the roller does not squeeze the pump tube 325, and virtually, it rotates idly. As a result, negative pressure is not generated. Further, there is no concern that the pump tube 325 is squeezed to create creeping. It is then desirable to provide the condition shown in FIG. 6 if any suspension for a long time is expected for turn-off of the power supply or the standby for recording.

In FIG. 5, the tube pump 324 is provided with a photo-interrupter 600, and with a flag 602 arranged for the roller guide 327, the phase-angle position of the roller 626 can be detected in the rotational direction. With the structure thus arranged, even if settling occurs for the pump tube 325, or when the roller guide 327 rotates reversely, that is, in the direction indicated by an arrow A310 under a smaller load that the roller 326 receives from the tube 325 due to the dent occurring, at a position in the groove 327a of the roller guide 327 of the shaft position 326a of the roller 326, which dent is caused by the sliding friction with the rotational shaft portion of the roller 326, or even if the roller 326 is not made retractable to the position shown in FIG. 6 due to an increased loading force needed for the roller 326 to retract, to thereby bring about the reverse rotation in a position at 326a in FIG. 5 as it is in the position, the distance for the roller 326 to squeeze the tube 325 can be controlled to be extremely short by retaining the roller position in the vicinity of the end portion of the tube guide (tube regulation surface) 329 before the initiation of the reverse rotation.

In other words, it is made possible to keep the position of the roller 326 at that of the shaft portion 326c as shown in FIG. 5 before beginning the reverse rotation, that is, to stop the position in the vicinity of the tail end portion of the tube guide 329 (or at the position in the vicinity of the head end portion depending on the direction in which the roller guide 327 rotates). In this way, when the roller guide 327 rotationally moves and comes to the area where the tube guide (regulation surface) 329, which regulates the position of the tube 325 against the compression of the roller 326, does not exist, the tube 325 is no longer compressed necessarily, irrespective of the retracted state of the roller. Further, when the roller 326 reversibly rotates and comes to the lowermost point in FIG. 5, the roller 326 interferes with the tube 325, and due to the charged resistance, the roller 326 moves to the position indicated by the shaft portion at 326b, thus preventing the opposite flow in the tube pump 324.

Here, at this juncture, the force, which is needed for moving the roller 326 from the position (compressed position) indicated by the shaft portion 326a to the position (idly rotational position) indicated by the shaft portion 326b, is extremely small, and the roller 326 can be retracted reliably irrespective of the settling condition of the tube 326. The roller 326 moves in the vertical direction in FIG. 5 by gravitation, and travels to the position indicated by the shaft portion 326b. Then, thereafter, the roll does not press the tube 326 even if the tube pump 324 continues rotating reversibly.

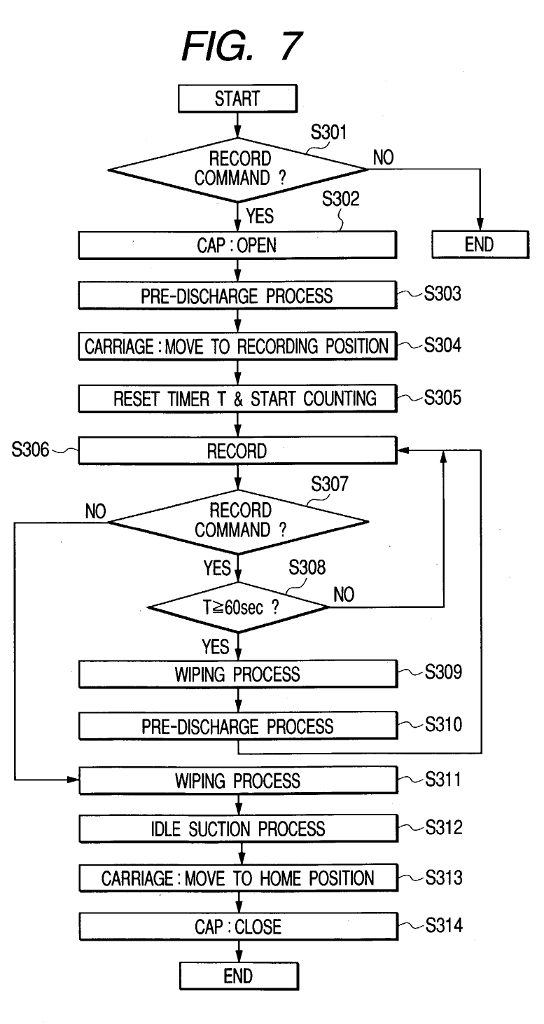

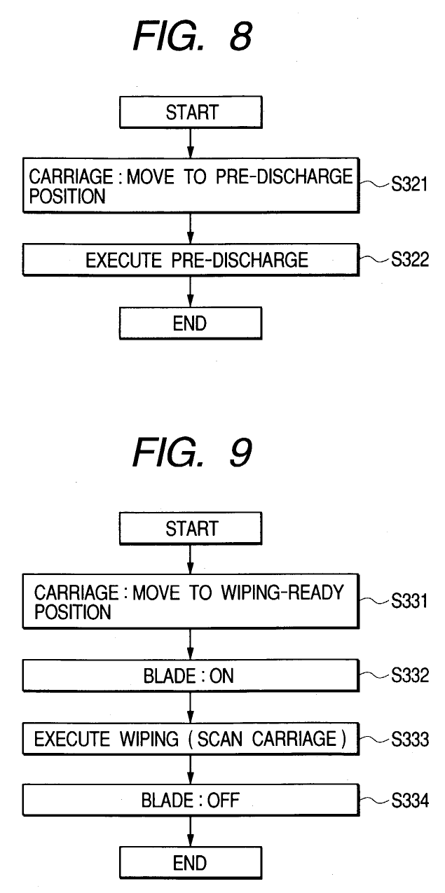

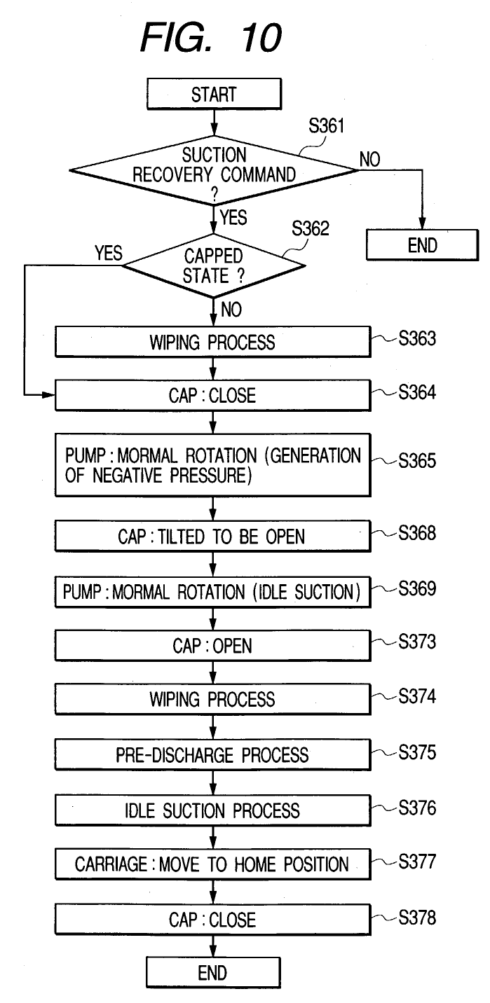

FIG. 7 is a flowchart that shows a series of operations of recording process and discharge recovery process for the ink jet recording apparatus in accordance with the present embodiment. FIG. 8 is a flowchart that shows the operation of pre-discharge process in FIG. 7. FIG. 9 is a flowchart that shows the operation of wiping process in FIG. 7. FIG. 10 is a flowchart that shows the operation of the suction recovery process in FIG. 7. Next, in conjunction with FIG. 7 to FIG. 10, the description will be made of the series of the recovery process operations at the time of recording.

In FIG. 7, when a recording instruction is received in S301, the motor 370 dedicated for use of recovery systems driving begins to rotate in S302 in the CCW direction (counterclockwise direction) in FIG. 3. Then, the camshaft 380 rotates in the direction indicated by the arrow A380, thus conditioning the cap to be open. Here, the pre-discharge process shown in FIG. 8 is carried out for the execution of pre-discharges.

In the pre-discharge process (FIG. 8), the carriage 200 moves to the pre-discharge standby position in S321. Then, in S322, the pre-discharge is executed. With the completion of pre-discharges for all the discharge ports, ink discharge is suspended to end the pre-discharge process.

Next, in FIG. 7, the carriage unit 200 moves in S304 to the recording position (in accordance with the present embodiment, the recording position either one of the sides selected from the recording positions arranged on both sides of the recovery unit 300). Then, in S305, the timer T is reset to zero, and counting begins. In S306, the carriage unit 200 discharges ink in accordance with recording information onto a recording sheet that has been conveyed to the recording position on the side where the carriage unit is positioned.

Next, in S307, whether any recording instruction is present or not is determined. If negative, the process proceeds to S311 where the wiping process is executed (FIG. 9).

If any recording instruction is present in the S307, the timer T is referenced in S308. If the timer T is less than 60 sec, the process returns to the S306 where recording is continued as it is. If the timer T is 60 sec or more, the wiping process (FIG. 9) is. executed in S309 for wiping off the ink that adhered to the discharge port surface 88, while in S310 the pre-discharge (FIG. 8) is executed. The operations from the S306 to the S310 are repeatedly performed until it is determined in S307 that there is no longer any recording instruction. In this respect, the pre-discharge process in the S310 is the process operation for discharging dried ink, ink of different kind, or the like that may be pushed into the discharge ports of the recording head 401 by the wiping process executed in the S309. Then, in the S307, if it is determined that there is no longer any recording instruction, the process proceeds to S311 where the wiping process (FIG. 9) is executed as described earlier.

In the wiping process shown in FIG. 9, the carriage unit 200 moves to the wiping standby position in S331. In continuation, the motor 370 rotates in the CCW direction in S332. Then, the leading end of the blade 303, which is in the downward direction, shifts to the condition where it is in the upward direction so that wiping is made possible (blade ON). Next, in S333, the carriage unit 200 moves and performs the wiping of the discharge port surface 88. The traveling speed of the carriage unit 200 then is not necessarily constant. It may be possible to change the speeds depending on the kinds of ink, for example. After all the area of the discharge port surface of the recording head 100 is wiped (cleaned by wiping) by the blade 303, the carriage unit 200 stops, and in S334, the motor 370 rotates the CCW direction to store the blade 303 downward, thus completing the wiping process. In this respect, since the rotation mechanism of the blade 303 is not directly concerned with the present invention, the detailed description thereof will be omitted.

Next, in S310 in FIG. 7, the pre-discharge process is executed to discharge the dried ink, the different kinds of ink, or the like that may be pushed into the discharge ports 89 due to the aforesaid wiping process. If there is no longer any recording instruction, the wiping process is executed in S311 as the ending operation of recording. Thus, after ink is removed from the discharge port surface, the motor 370 rotates in the CW direction to drive the pump 324 in S312 for the idle suction process in order to discharge the ink, which is still retained in the cap 308, to waste ink process means (not shown).

Next, in S313, the carriage unit 200 moves to the home position, that is, the capping position facing the recovery unit 300, and in S314, the motor 370 rotates in the CCW direction to cap the recording head 100, thus completing the series of operations of the recording process.

In a case where the recording head 100 is not in use for a long time, ink in the discharge port is solidified and fixed thereto or discharge defects (including disabled discharge) may take place due to the mixture of air-bubbles in the discharge port. In order to recovery and maintain the ink discharge performance by eliminating such discharge defects, the suction recovery process, such as shown in FIG. 10, is executed automatically or manually.

Next, the suction recovery process will be described. In FIG. 10, when a suction recovery instruction is received in S361, at first. Then, in S362, detection is made to ascertain the current status of the recording apparatus. Here, if the recording apparatus is on standby and the recording head 100 is capped, the process proceeds to S364 (cap closed). Otherwise, the process proceeds to S363 where the wiping process is executed, and after that, capping is made in S364. Next, in S365, the motor 370 rotates in the CW direction to drive the pump 324, thus exerting negative pressure in the cap. The suction recovery operation is performed to suck ink from the discharge port 89 by means of the suction operation (by means of the negative pressure thus exerted) in the capping condition in the S365.

In continuation, after the execution of the suction recovery operation (S365) to such ink from the discharge port 89 in a predetermined amount, the motor 370 rotates in the CCW direction in S368 to lower the cap 308 while causing it inclined diagonally. Thus, the portion on one side of the cap is allowed to part from the discharge port surface 88 of the recording head 100, and release the inside of the cap to the atmosphere. Next, in S369, the motor 370 rotates in the CW direction to actuate the pump 324 serving as negative pressure generating means for the execution of the idle suction process to suck ink remaining in the cap 308, the cap tube 338 and the pump tube 325. Then, sucked ink is discharged to the waste ink process means.

In continuation, in S373, the cap 308 is allowed to be made part from the discharge port surface 88 to provide the cap open condition. Then, in S374, the aforesaid wiping process is executed; in S375, the pre-discharge process is executed; and in S376, the idle suction process is again executed. Thus, lastly, in S377, the carriage unit 200 movers to the home position, and in S378, the motor 370 rotates in the CCW direction to keep the recording head 100 in the capping status (in the condition where the discharge port 89 is covered) to complete the series of the suction recovery process.

Here, in accordance with the present embodiment, the camshaft 380 is provided with a cap cam (not shown) fixed thereto, and also, a cap cam sensor is provided, which is formed by a photo-interrupter having the cap cam as flag. Then, the structure is arranged so as to detect the phase of each of the cam including the one used for the up and down driving of the cap fixed to the camshaft 380, (that is, used for the opening and closing operations of the cap 308), by the result of detection effectuated by the cap cam sensor.

(Second Embodiment)

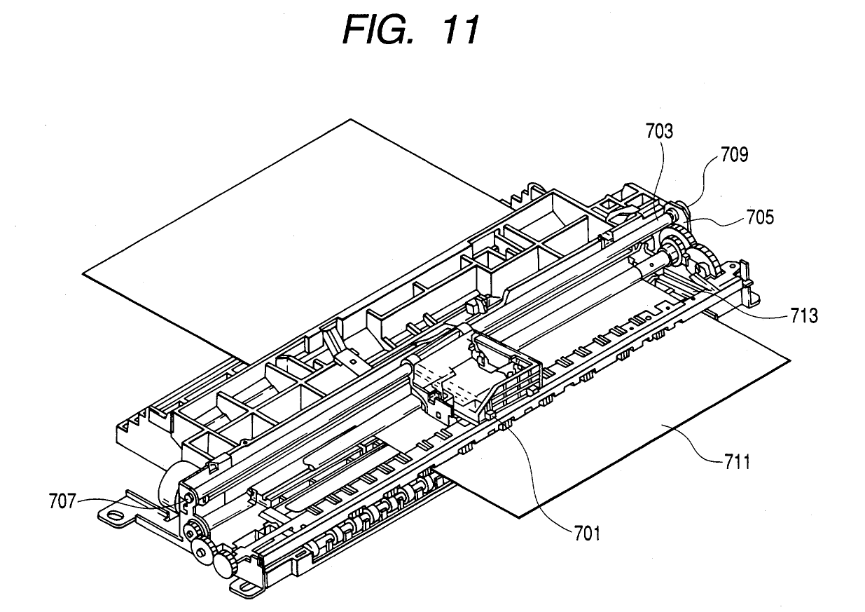

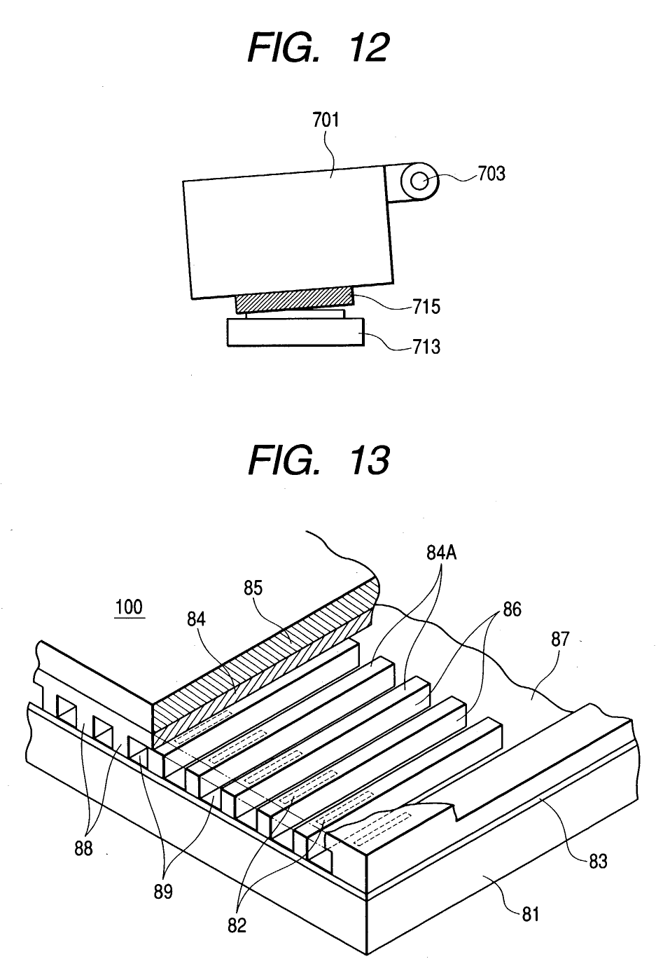

FIG. 11 is a perspective view that schematically shows a second embodiment of the ink jet recording apparatus to which the present invention is applicable. FIG. 12 is a side view that schematically shows the posture of the recording head and cap when idle suction is performed for the ink jet recording apparatus represented in FIG. 11.

For the first embodiment described above, the structure is arranged so that the idle suction is executed while a part of the cap is released by inclining the cap 308 to the discharge port surface 88 of the recording head 100, thus allowing the cap to be made apart from the discharge port surface. However, the present invention is not necessarily limited to such structure. For example, as shown in FIG. 12, the structure may be arranged so that the idle suction is made executable, while releasing a part of a cap 713 by inclining a recording head 715 to the cap 713 so as to allow the head to be made apart from the cap in the diagonal direction.

In FIG. 11 and FIG. 12, the discharge port surface (lower face) of the recording head 715 is arranged to be substantially in the horizontal direction. A guide shaft 703 that guides the movement of a carriage 701 is fixed to a frame 705 of the recording apparatus at both ends thereof, and portions 707 to be fixed to the frame 705, each arranged for either end of the guide shaft 703, is made eccentric. Also, one end portion of the guide shaft 703 is fixed to a gear 709. The gear 709 rotates by driving the driving means (not shown) which is connected with the gear 709, thus making it possible to adjust the rotational position of the guide shaft 703.

In other words, with the adjustment of the rotational position of the guide shaft 703, the postures of the carriage 701 and the recording head 715 mounted on the carriage 701 (the angles thereof to the horizontal plane) can be adjusted. In this respect, angle adjustment means of the kind can be used as means for adjusting the distance (to a recording sheet), that is the distance between the discharge port surface of the recording head 715 and a recording sheet 711 (recording material) to be conveyed on the lower side thereof.

Then, when the cap 713 and the discharge port surface of the recording head 715 should be made apart, driving means is actuated to rotate the guide shaft 703 to incline the discharge port surface of the recording head 715 at a designated angle in the horizontal direction. As a result, the recording head 715 parts from the cap 713 while being inclined as shown in FIG. 12, and a part of the cap 713 on the guide shaft 703 side is released diagonally to the discharge port surface of the recording head 715. In other words, in accordance with the second embodiment, too, it is made possible to release the portion of the cap on the side opposite to the suction port side, while inclining it diagonally to the discharge port surface of the recording head.

In accordance with the second embodiment, there is no need for inclining the recording head in advance from the horizontal position thereof. Also, it may be possible to move the cap up and down while maintaining the posture of the cap horizontally.

In this respect, if the situation is such that the cap opening is impossible only by the inclination of the recording head 715, it may be possible to execute the operation of inclining the recording head in combination with the parting operation of the cap (including the inclining and rotating operations thereof). Here, the mechanism for raising the recording head (the inclination mechanism thereof) described in conjunction with FIG. 11 and FIG. 12 is not necessarily arranged to dually function as the mechanism to adjust the distance to the recording sheet, which is made capable of adjusting a distance between a recording head and a recording material (such as recording sheet) (that is, a clearance between a head and a recording sheet). This mechanism may be arranged as that one dedicated for opening and closing a cap only.

In this respect, the present invention is widely applicable to the serial type recording apparatus in which recording is performed with the main scans in the direction intersecting with the conveying direction of a recording sheet, the line type recording apparatus in which recording is performed only with the sub-scans in the conveying direction of a recording material, or the like, irrespective of the recording methods to be adopted, and the same functional effects can be demonstrated in each apparatus.

Also, the present invention is equally applicable to the recording apparatus that records using one recording means, the color recording apparatus that uses plural recording means for recording in ink of different colors, or the gradational recording apparatus that uses plural recording means for recording in one color but in different densities, or, further, the recording apparatus in which these methods are combined, and the same effects are attainable in each apparatus.

Furthermore, the present invention is equally applicable to the structure that uses an exchangeable heat cartridge in which a recording head and an ink tank are integrally formed, the structure that adopts a recording head and an ink tank as separate members, which are connected by use of a ink supply tube or the like, and others irrespective of the structures of the recording head and ink tank arrangement, and the same effects are obtainable in each structure. Here, in the case of ink jet recording apparatus, the present invention is of course applicable to the one provided with recording means that uses electromechanical converting member, such as piezoelectric element, or the like, and of such means adoptable, the invention produces excellent effects on the ink jet recording apparatus the uses recording means having the method of discharging ink by the utilization of thermal energy, because With this method, it is made possible to attain highly precise recording in high density.

As clear from the description that has been made above, the ink jet recording apparatus that records by discharging ink from recording means is provided with the cap, which covers the discharge ports of recording means; suction means for sucking ink from the discharge ports of recording means; and the ink flow path that connects the suction port formed for the cap to the aforesaid suction means in accordance with the present embodiment, and at least, when the cap is released after the suction recovery process, the portion of the cap on the side opposite to the suction port is made apart from recording means diagonally with the posture inclined to the recording means, and the structure is arranged so that the posture of the cap after having parted from recording means is made horizontal or made slightly lower on the portion on the suction port side. Therefore, when idle suction is effectuated inside the cap after the cap has been parted immediately after suction recovery process or the like, it becomes possible to suck and remove ink remaining in the cap and others efficiently, hence minimizing the amount of ink remaining in the cap, on the discharge port surface of recording means, or the like, for the provision of the ink jet recording apparatus capable of maintaining the ink discharge performance thereof stably at all times.

What is claimed is:

1. An ink jet recording apparatus for recording by discharging ink from recording means comprising:
a cap for covering a discharge port surface of said recording means;
suction means for sucking ink from said discharge ports; and
ink flow paths connecting the suction port arranged for said cap to said suction means,
wherein after sucking ink from said discharge ports by said suction means, there is made apart the opposite side of said cap to the side where said suction port is arranged, and when said cap and said recording means are set apart, said cap is horizontally postured or in a posture having the side of said suction port arranged therefor made lower than horizontal.

2. An ink jet recording apparatus according to claim 1, wherein when said cap is made apart from said recording means, said cap performs idle suction with said cap being horizontally postured or in a posture having the side of said sucking port arranged therefor made lower than horizontal.

3. An ink jet recording apparatus according to claim 1, wherein the inclined angle of said recording means to the horizontal plane is equal to or more than the incline angle of said cap to said recording means when the opposite side of said cap to the side opposite to the side where said suction part is arranged is made apart.

4. An ink jet recording apparatus according to claim 1, wherein said cap and said recording means are made apart by the movement of said cap.

5. An ink jet recording apparatus according to claim 1, wherein said cap and said recording means are made apart by the movement of said recording means.

6. An ink jet recording apparatus according to claim 1, wherein said cap and said recording means are made apart by the movements of said cap and said recording means together.

7. An ink jet recording apparatus according to claim 5, wherein the distance between said recording means and a recording material is changed by use of a movement mechanism for moving said recording means.

8. An ink jet recording apparatus according to claim 1, wherein said recording means is provided with electrothermal converting element for generating thermal energy to be utilized for discharging ink.

9. An ink jet recording apparatus according to claim 8, wherein said recording means discharges ink from discharge ports by utilization of film boiling generated in ink by thermal energy generated by said electrothermal converting element.
